(19) United States
(12) Patent Application Publication
(10) Pub. No.: US 2017/0233201 A1
(43) Pub. Date: Aug. 17, 2017

(54) IMPROVED APPARATUS FOR AUTOMATICALLY PALLETIZING CONTAINERS AND RESPECTIVE METHOD

(71) Applicant: UNITEC S.P.A., Lugo (IT)

(72) Inventor: Luca BENEDETTI, Savarna (IT)

(73) Assignee: UNITEC S.P.A., Lugo (IT)

(21) Appl. No.: 15/502,283

(22) PCT Filed: Aug. 6, 2015
(86) PCT No.: PCT/IB2015/055959

§ 371 Date: Feb. 7, 2017

(30) Foreign Application Priority Data
Aug. 8, 2014 (IT) PN2014A000040

(51) Int. Cl. B65G 61/00; B65G 57/24

(52) U.S. Cl. CPC B65G 61/00; B65G 57/24

(57) ABSTRACT

The object of the present invention is to improve the efficiency of an apparatus for palletizing which serves a plurality of conveyors transporting respective successions of cases, realising a storage means on the unloading area of each conveyor, so that during the period of storage of the cases coming from the same conveyor, the palletizer is transferred in correspondence of another conveyor wherein the respective storage has already been completed, so as to use a sole palletizer for a plurality of distinct conveyors.

This apparatus for palletizing a plurality of cases comprises a conveyor with an unloading area, an open structure composed of a plurality of support planes basically identical and arranged vertically one on top of the other, and separated by respective hollow spaces, first pushers which displace the cases from said unloading area of said mobile conveyor, towards and into a respective one of said hollow spaces, a transferring plate in a position adjacent to said open structure, displacement means, in particular second pushers apt at transferring said cases contained in respective one of said hollow spaces from it towards and on a palletizing means.

The present invention relates to an improved automatic apparatus for loading onsingle “pallets”, (the term is worldwide known and therefore it will be used without any further details) successively ready to be loaded with a plurality of containers or “mosaics” (the term will be explained later); these containers and/or mosaics are loaded in layers that is on overlapping planes and of course loaded in succession, so that a lower layer is the support base for the upper layer.

Hereinafter the term “plane” will be used to identify a general horizontal plane whereon a respective layer of containers/mosaic is supported.

Furthermore, the invention relates to the respective operating method.

The invention relates in particular to the handling and loading, on respective pallets, containers, especially cases, loaded according to different procedures depending on both the type of product being collected, and on the characteristics of the same containers.

Hereinafter, for a greater compliance with the object of the invention, it will be assumed that such containers contain vegetable products or in general horticultural products, but being understood that the invention is applicable and can be used for loading, on respective pallets, containers carrying materials/products of a completely different kind.

It is known that, in particular in the sector of loading pallets with cases/containers containing vegetable/fruit on layers or overlapping planes, the quantity of products and hence the respective cases to realise and transport is very high, and their handling techniques are rather standardised; the methods for handling and transporting such cases have in common both the way in which such cases are made ready to be transported, and the way in which they are grouped together and finally transported.

As for the way with which such cases are made ready to be transported, it consists in loading a succession, also not continuous and at not predetermined intervals of single cases to be transported on a mobile conveyor that can be a belt, catenary or roller conveyor of a conventional type and universally known.

Regarding instead the way with which said cases are assembled and readied to be transported, the most efficient and common way consists in loading a plurality of said cases on a respective pallet, thus said cases are arranged on overlapping planes or layers so as to optimise the utilization of each pallet; moreover, even if each of said layers can be formed by only one case, if the reciprocal sizes of said pallets and said cases allow that, each of said layers is generally formed by more cases arranged on the same layer so as to optimise the usable surface of the respective pallet.

In order to load said cases on the respective pallets, machines or specific apparatuses known as “palletizers” are generally used.

Such apparatuses are made according to very varied ways depending on the constraints and conditions wherein they have to operate.

From U.S. Pat. No. 5,135,351 it is known an apparatus for palletizing and depalletizing a plurality of homogeneous loads, each one typically consisting of a single stack of flat and thin products, such as sheets of paper or in general printed publications, stacked in succession and vertically one by one on a sole pallet.

To this purpose, single stacks of such flat and thin products are each one of them loaded on a respective intermediate plane (called “intercarrier 2”) and subsequently each load, consisting of a respective intermediate plane, supporting a respective stack of products is stacked one by one, by means of moving the respective intermediate plane.

The object of such patent is not that of forming a pallet rapidly and efficiently so as to move it onto a means of transport to send it away, but to make it possible that the various stacks can be formed in an ordered, and above all, stable and safe way, so as to avoid the risk of collapsing of part of the various loads stacked one on top of the other on the same pallet; but above all, this patent allows to depalletise the various single loads, by means of a method for “undoing” in an ordered and safe way the overall load, comprising the various intermediate planes and the respective stacks resting on a same pallet.

Basically the apparatus described therein discloses a palletizer of an improved type for the particular use as a means for storing and retrieving in an ordered and safe way documents and the like, and it does have any advantages as a means and method for forming pallets that have to be rapidly and efficiently loaded with a great amount of containers coming from different origins, such as different conveyors or mobile planes.

From patent DE 3107495 it is known another apparatus for palletizing apt at loading in succession and totally automatically a plurality of single containers (Zusnittelstapel 1) on a respective pallet; after the loading of the pallet, this one is moved away and its place is taken by a successive pallet whereon the same loading operation is repeated.

Anyway, even if the optimization of the area on the pallet is achieved forming a suitable “mosaic” of single containers, there is still the inconvenience that the palletizer is fixed and can only work with only one conveyor, and therefore it necessarily affected by inevitable slowing down or discontinuity of the feeding of products coming from the sole mobile conveyor.

It is specified that in the present description with the term “mosaic” it is meant the assembly of more containers arranged and oriented, and associated with respect to one another on a same horizontal plane and that together they constitute the overall load forming a single common load layer on the same pallet.

Further, that palletizer is capable of loading only a single layer (or “mosaic”) of containers on the same pallet, and therefore it is not capable of loading, in an optimal way, a same pallet to its highest capacity, that is on more overlapping layers.

From U.S. Pat. No. 5,297,924 it is known an overall apparatus for palletizing and transferring a plurality of already formed and loaded pallets; this apparatus is capable of transferring a sequence of bodies also having very different sizes, incoming from a conveyor, to a plurality of pallets each of which is arranged on a loading area of a respective outgoing conveyor.

In order to transfer the various bodies from the incoming conveyor towards and

on various outgoing pallets, it is used a rotating transferring means which, suitably associated with rails allowing its horizontal displacement and according to a rectilinear route, is made able to access both the collecting area of the incoming conveyor, and to carry the various bodies on a respective pallet arranged in the loading area of pallets on a respective outgoing conveyor.

In particular the patent aims at a method for automatically feeding pallets on the loading areas of respective outgoing conveyors so as to make the apparatus completely automatic and highly flexible.

Even though it has to be recognized that the presence of a sole palletizing means (transfer device 52, self propelled robot 54) combined with guide rails improves the efficiency and the overall performances of the whole apparatus since said palletizing means is single but multi-purpose, yet it has to be observed that such apparatus is particularly meant for a sector typical of the “large-scale retail trade”, and therefore it is capable of neither loading the single pallets with more overlapping layers of products, nor of loading on a single pallet an organized mosaic of products whose horizontal dimensions are compatible with the optimization of the surface offered by each single pallet.

It would therefore be desirable, and it is the main object of the present invention,

to realize a type of apparatus which overcomes the described inconveniences and in particular which offers the possibility and advantages of:
using a sole palletizer means that serves and palletizes the containers coming from distinct mobile conveyors and fed with containers in an independent and casual way, in order to form a suitable mosaic of containers before these are loaded on the same pallet, and realize a succession of said mosaics,
loading each one of the succession of said mosaics on more overlapping layers on the same pallet, so as to form a stack,
and in particular providing storage means associated with incoming conveyors so as to form corresponding complete loads of mosaics before the latter are transferred on various pallets using a sole means of palletizing for a time interval strictly necessary to transfer the whole complete load on a respective pallet.

Such object, and others which will be better described hereinafter, will be achieved by the type of apparatus made and operating, for exemplification only but not limited to, with reference to the appended figures as hereunder shown and described, wherein:

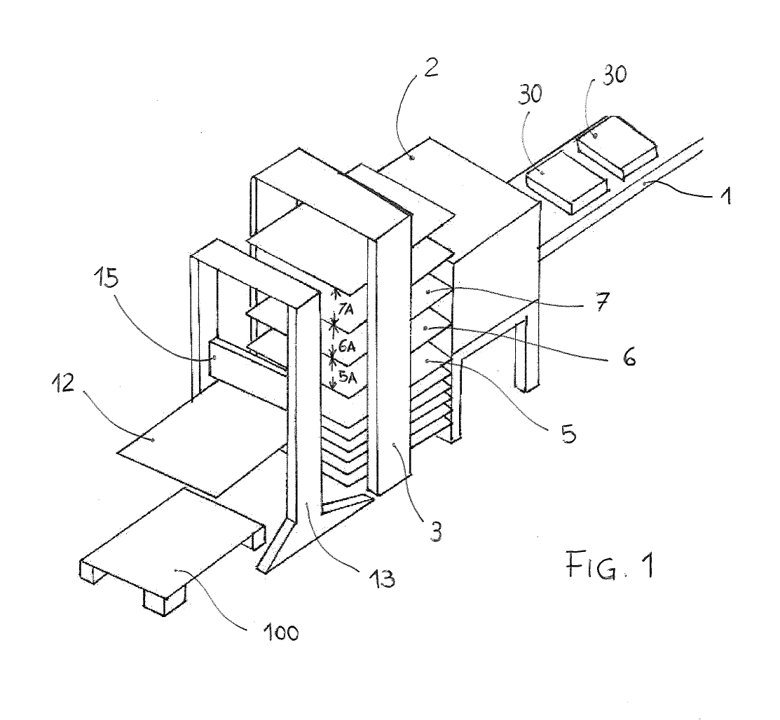

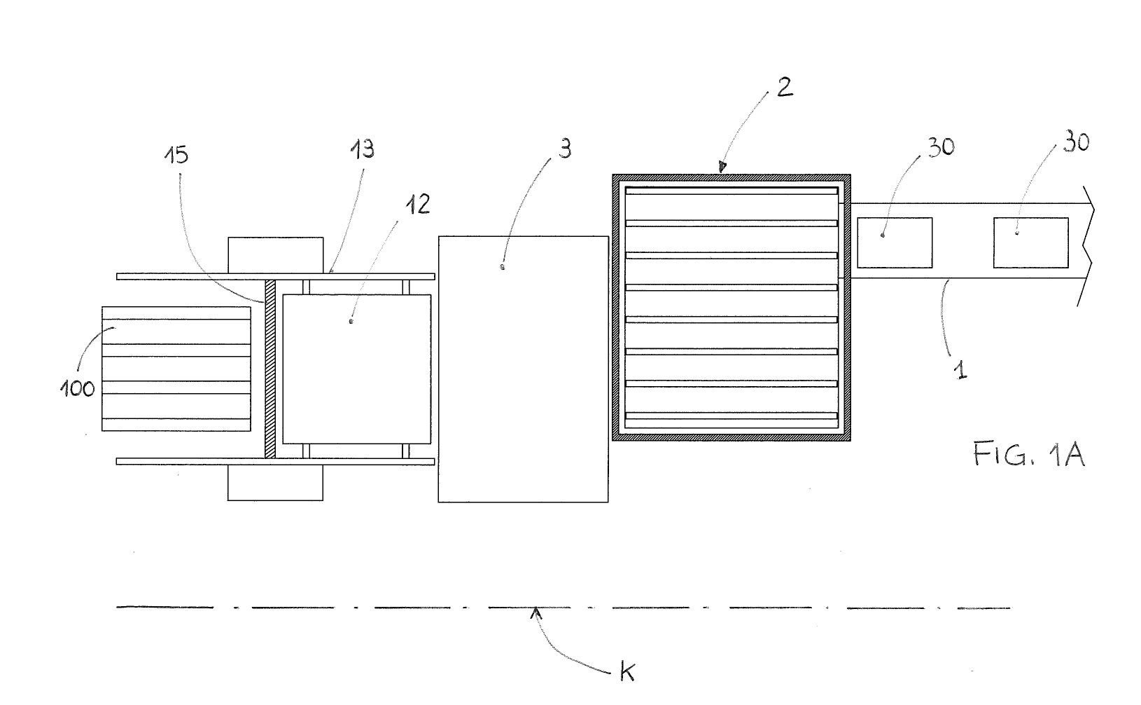

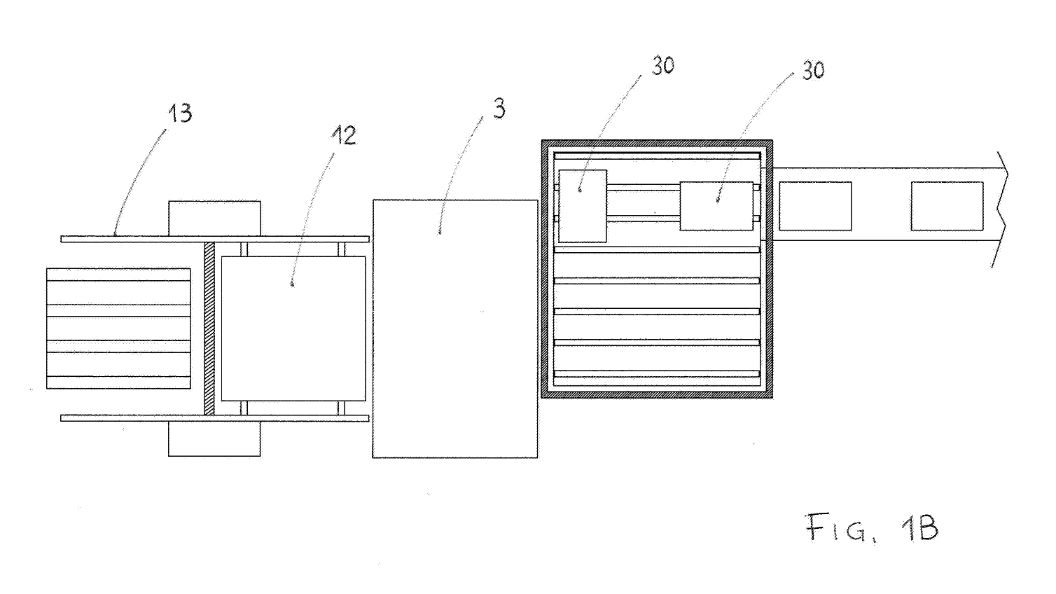

FIG. 1 shows a prospective view of a simplified and symbolic representation of the apparatus of the invention,

FIGS. from 1A to 1H show respective plan views and top views of a schematic representation of likewise operating steps of an apparatus according to the invention,

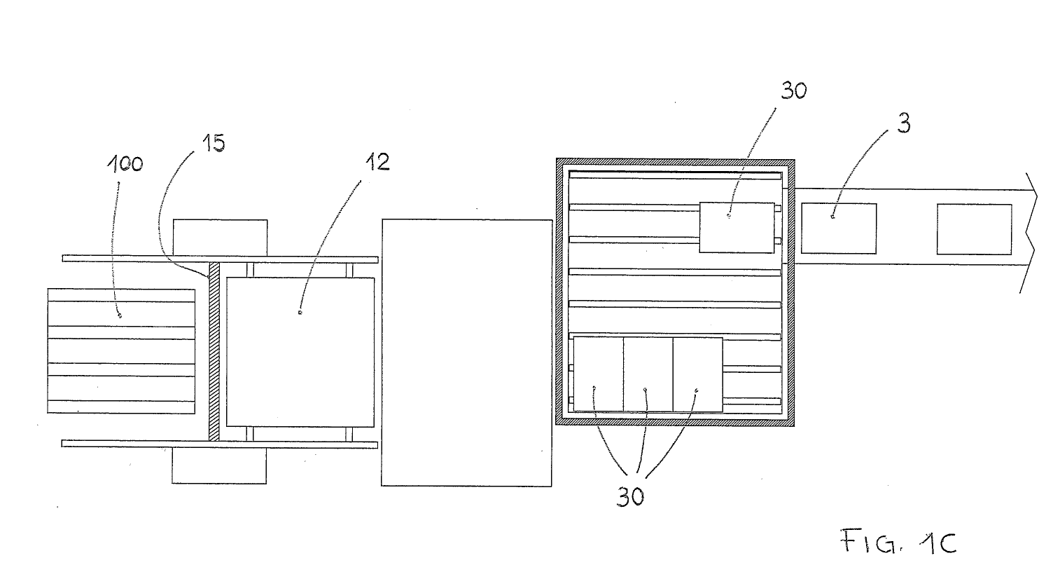

FIG. 2 shows a prospective view of an assembly composing the apparatus of the previous figures, in a main step of its operation,

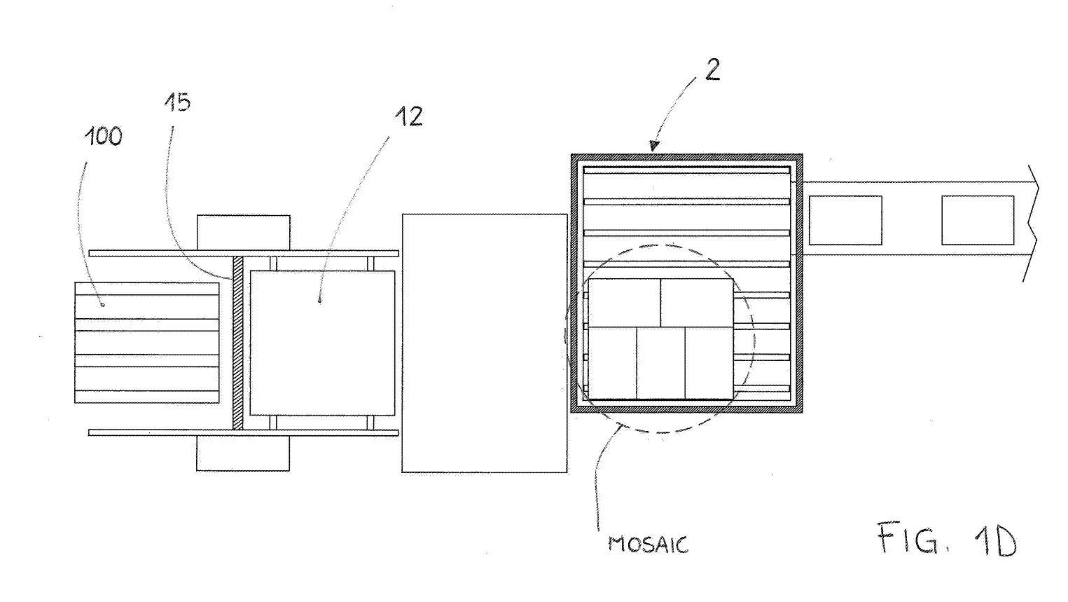

FIG. 3 shows an exemplificative and schematic view of a portion of the assembly of FIG. 2,

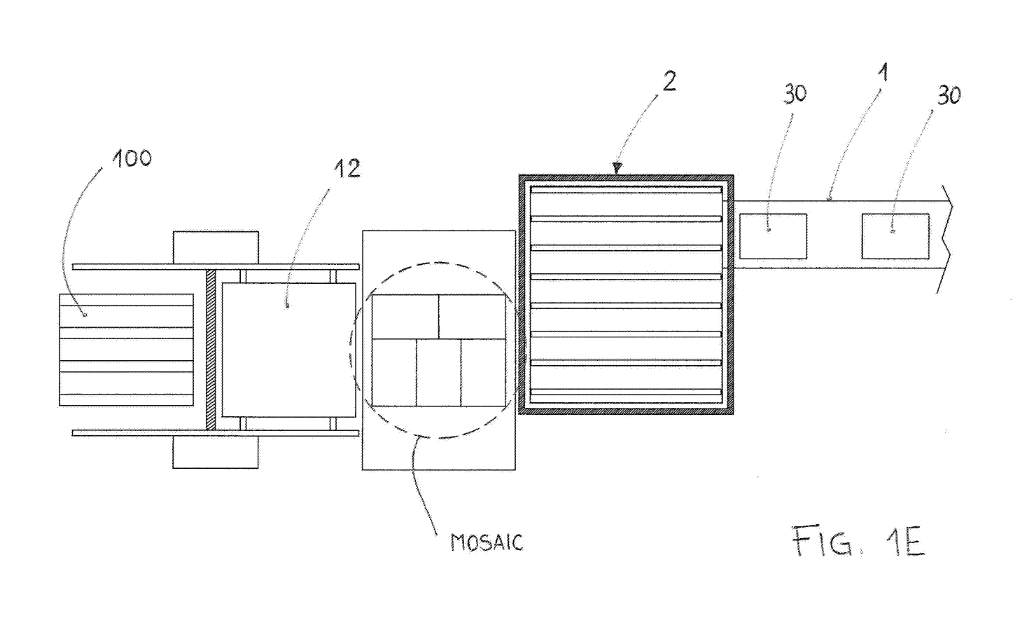

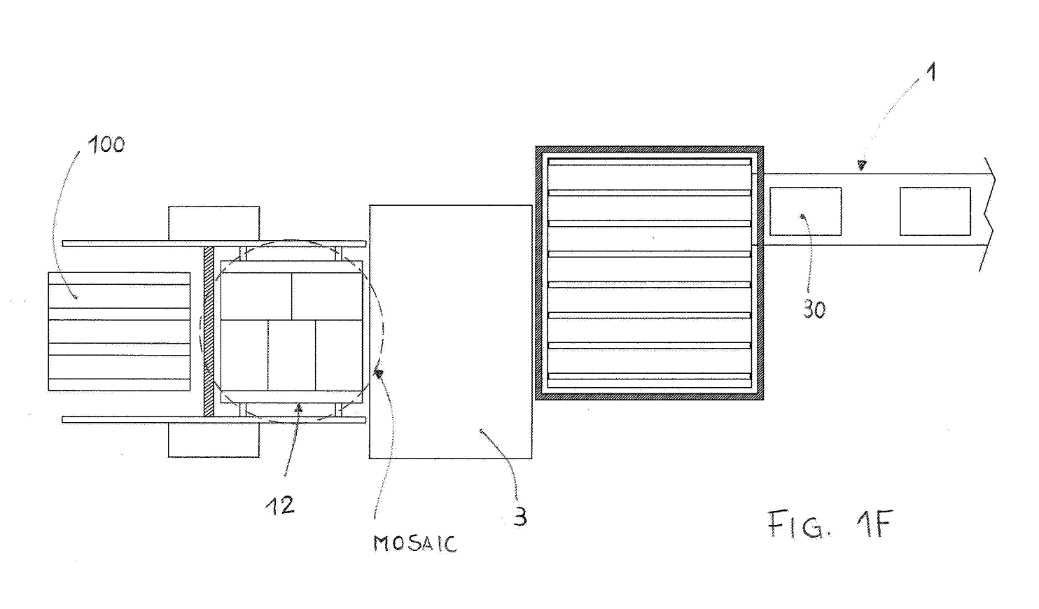

FIG. 4 shows a side vertical plan view and in a simplified form of the apparatus of the previous figures seen from the observation plane “K” of FIG. 1A,

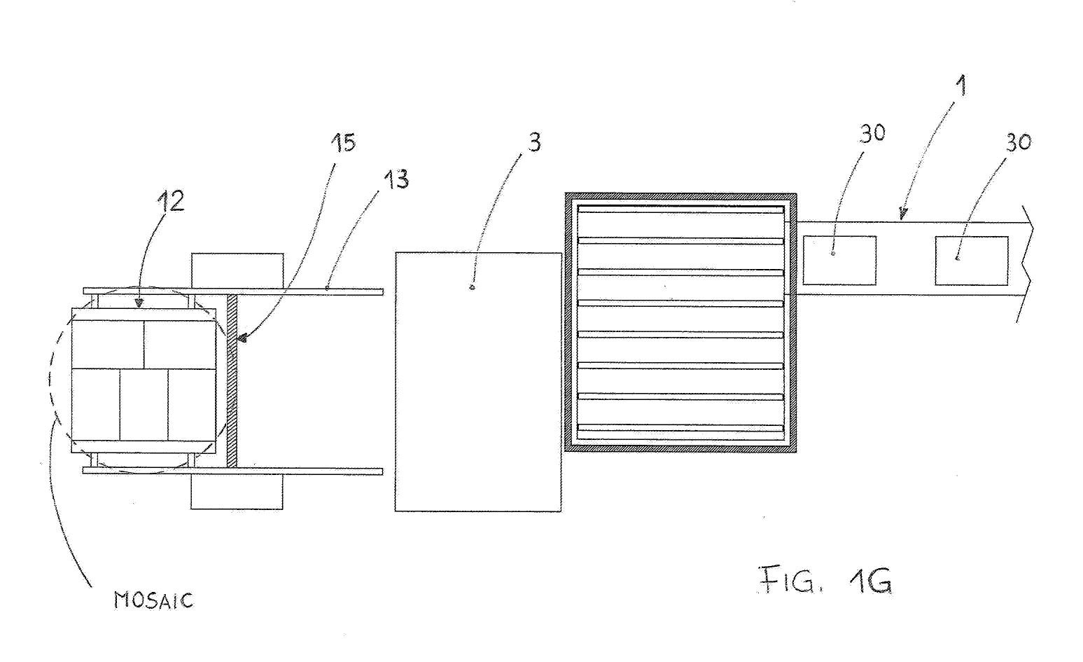

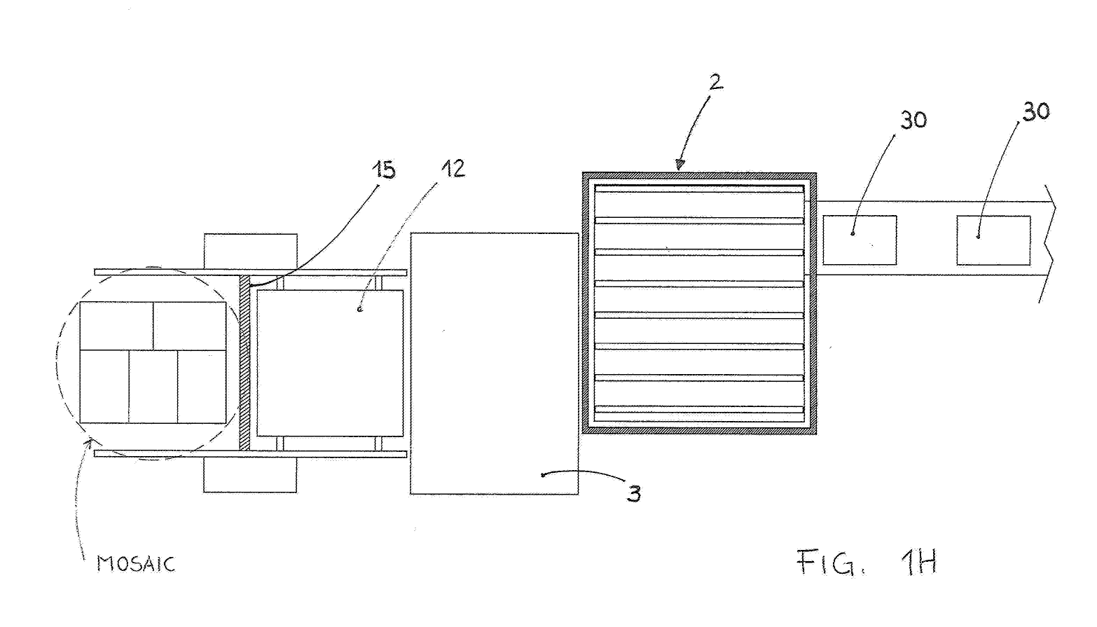

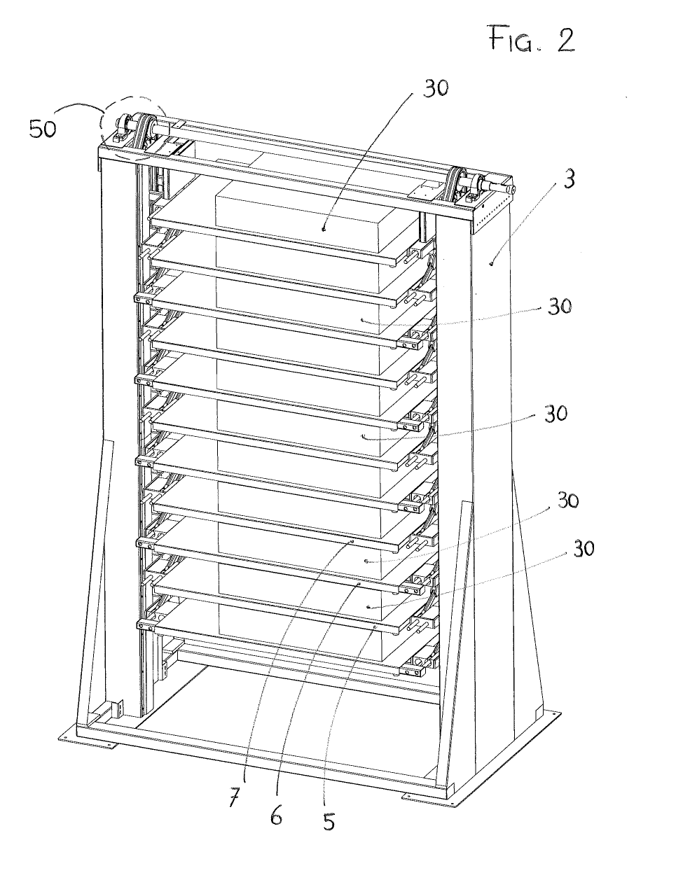

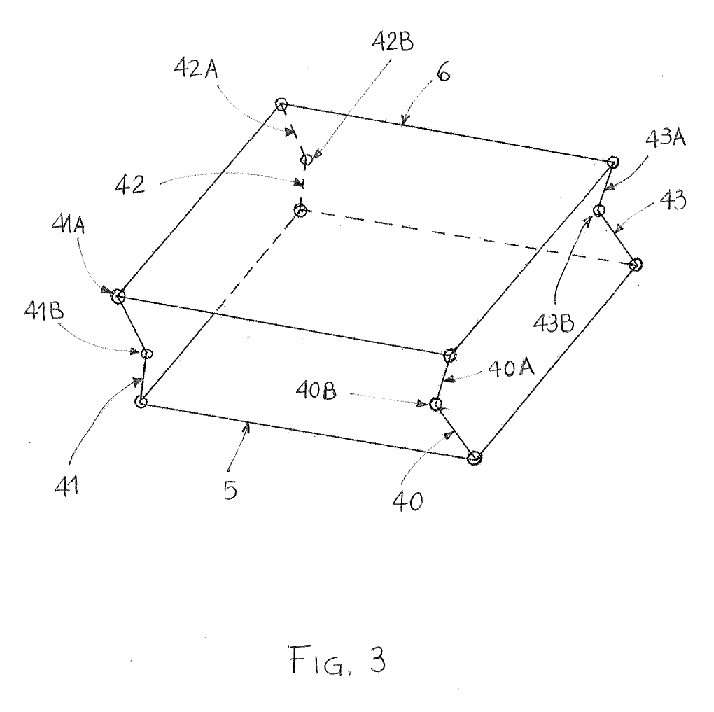

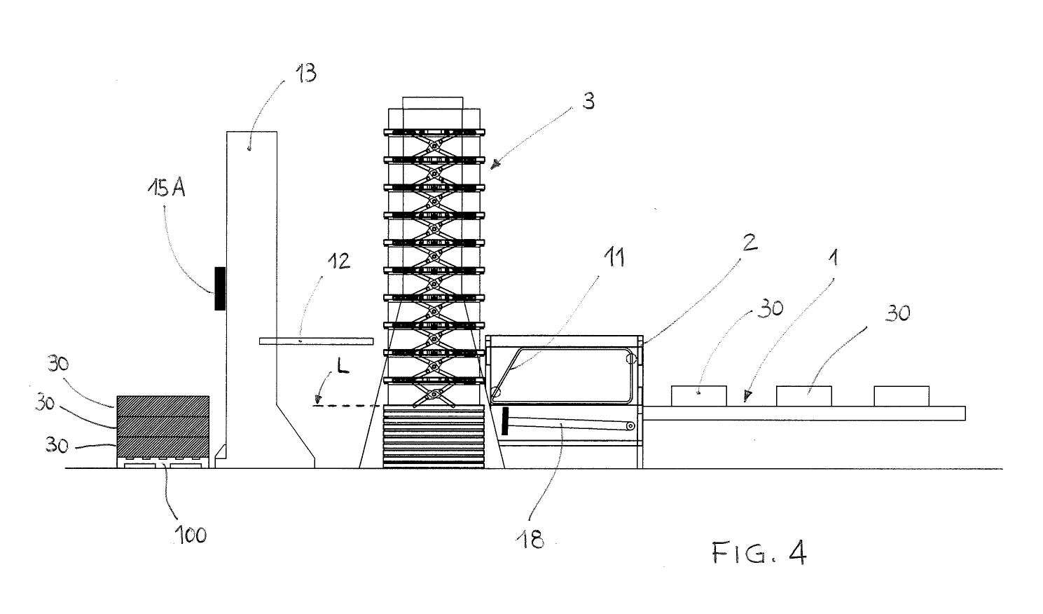

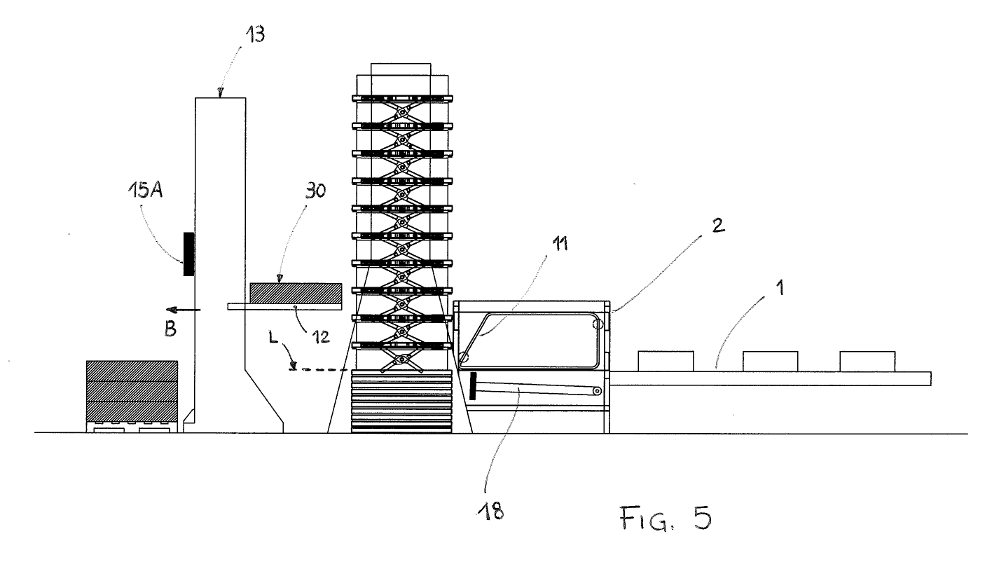

FIGS. 5, 6 and 7 show likewise vertical plan views, similar to FIG. 4, in different and subsequent respective operating steps,

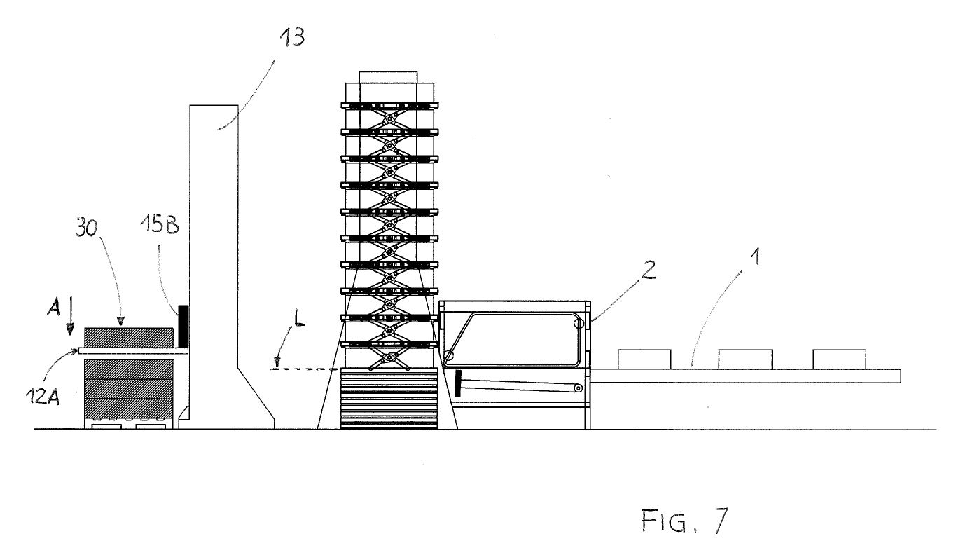

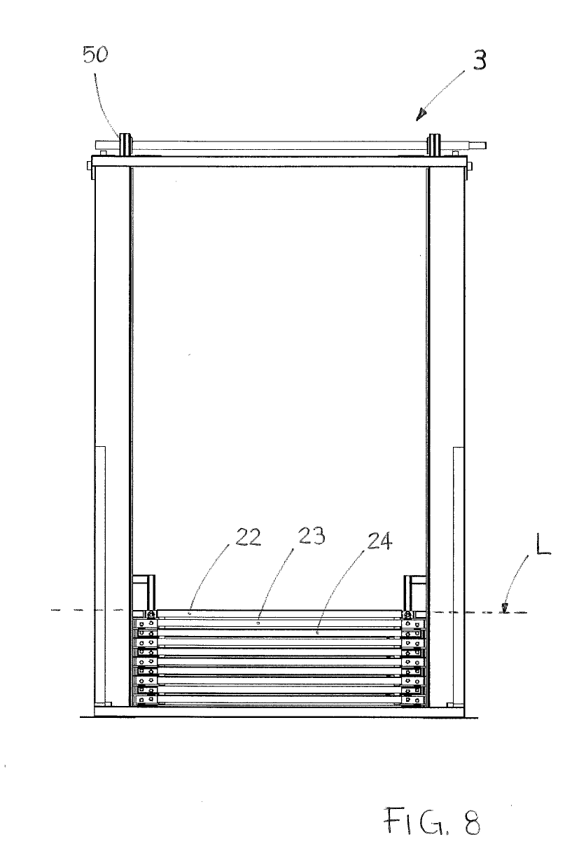

FIGS. 8, 9 and 10 show likewise views of an assembly composing the apparatus of the invention, in respective operating states,

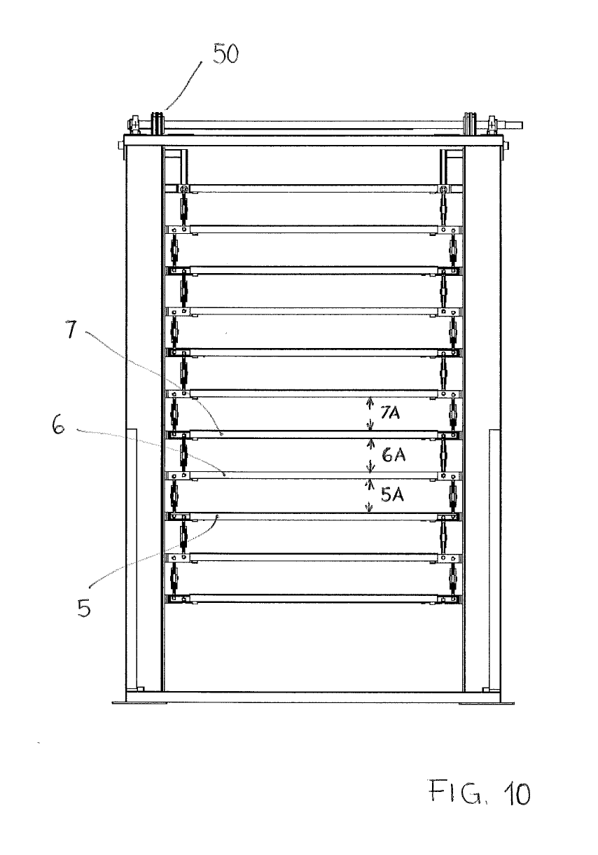

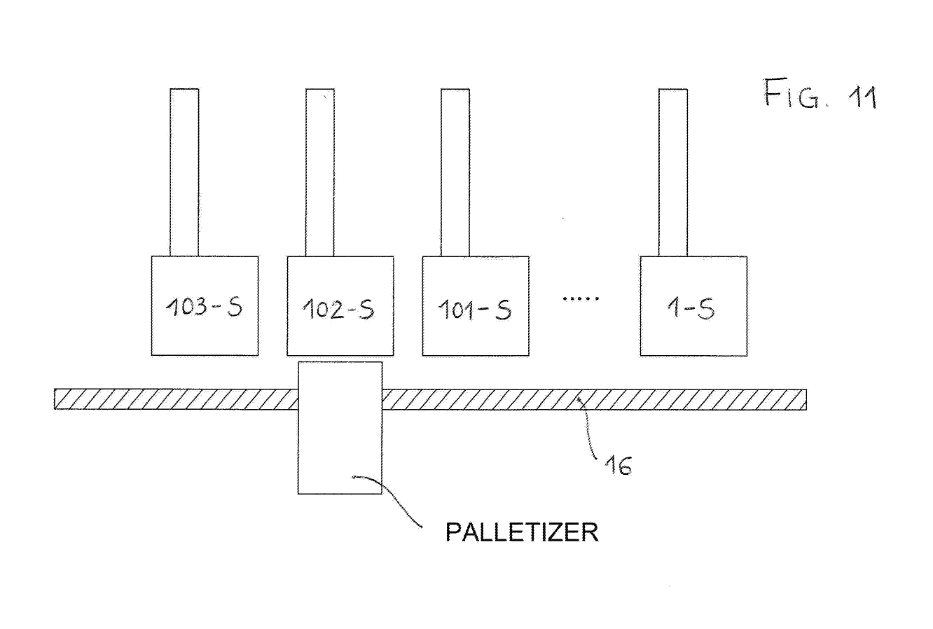

FIG. 11 shows a top plan view of a form of improved and expanded embodiment of the apparatus of the previous figures, in a definite operating state,

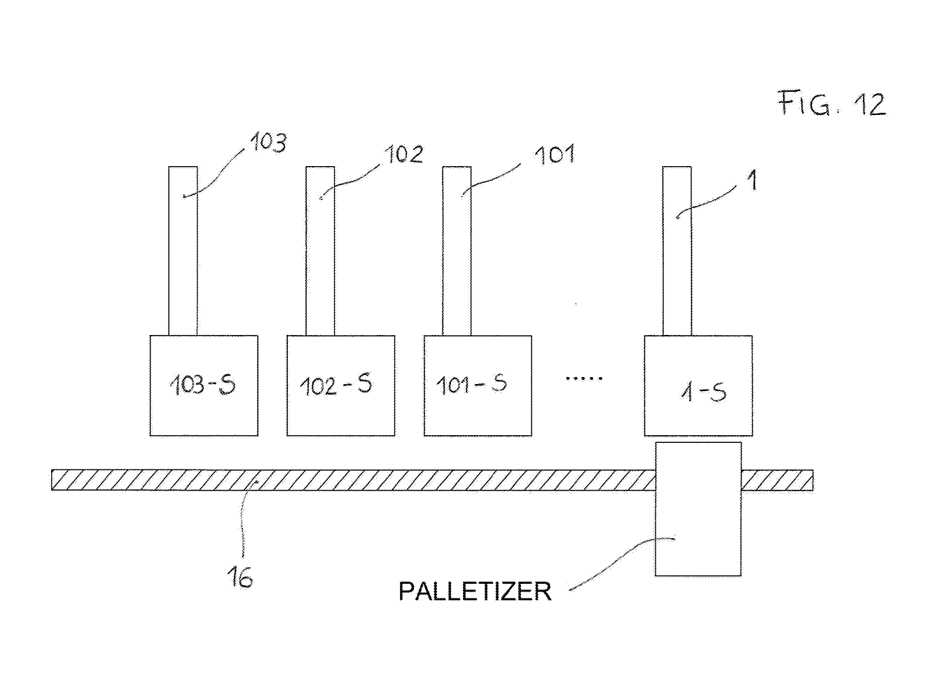

FIG. 12 shows a top plan view of the apparatus of FIG. 11, in a different operating state.

With reference to figures, an apparatus for palletizing a plurality of containers 30 available in a sequential way comprises:
at least a conveyor 1, and in general a mobile conveyor known per se, for example operating with a roller, or a catenary etc. running on a horizontal plane with a closed ring motion,
a handling and ordered collecting group 2 arranged downstream said closed conveyor 1, and provided with a leaning plane able of supporting a respective container or a plurality of containers,
at least an open structure 3 arranged downstream and accessible by the containers arranged on said handling and collecting group 2.

The fundamental content of the invention is based on the nature and operation of said open structure 3; its function is that of being a temporary vertical storing means such as a vertical storage unit (BUFFER), provided with a plurality of leaning distinct planes, basically rigid, 5, 6, 7, 8 . . . and overlapping one another but separated one from the other so as to form, if said planes 5, 6, 7, 8 . . . are rectangles, a parallelogram-like structure, as shown in FIGS. 2, 3, 8, 9, 10.

It must be said beforehand that, even though this aspect will be better explained and analysed later, said rigid planes 5, 6, 7, 8 . . . can be either separated one from the other or, during one of their operating step, they can also be moved into contact one with the other, roughly similar to a stack of planes overlapping one another.

Since said planes are at first separated one from the other, between each pair of contiguous and overlapping planes, of course, there will be formed a respective hollow space 5A, 6A, 7A . . . .

Said parallelogram-like structure is completed, for its stabilization as a solid body, by four vertical posts 11, 112, 113, 114 applied at the corners of said rigid planes 5, 6, 7, 8 . . . so that, after such completion and stabilization, said open multi-flat structure 3 is as in FIGS. 2, 9, 10, and that is, it is as an open multi-flat structure, provided with said rigid planes 5, 6, 7, 8 . . . between which there are interposed respective said hollow spaces 5A, 6A, 7A . . .

Said multi-flat structure 3 is provided with lifting means, not shown, apt at lifting and lowering it selectively, and with modes and sequence which will be described hereinafter in detail.

At this point a clarification is necessary: generally on each pallet it is loaded a plurality of layers of containers in succession and vertically, and leaning one on the other; generally each layer contains not only one container, but a respective plurality of containers, so as to optimise the pallet useful surface.

The modes with which the various containers are managed, arranged and loaded so as to form an assembly which becomes a single layer of containers, also called “mosaic” are well known to the skilled in the art and therefore they are not included in the present invention.

Therefore hereinafter it will be meant that when it is described in general the motion of “containers” it can be indifferently referred to either a single container or to a respective said “mosaic” comprising said container and all the others comprised in the respective mosaic, if present.

In the embodiment of the present invention it is meant that said “mosaic” is formed on said handling and ordered collecting group 2, by means of a suitable operation of the associated elements to said same group 2 and that typically are formed by:
one or more roller conveyors
and one or more pushers.

Since such elements apt at forming said “mosaic” are known per se, as well as their overall operation, their description is avoided for simplicity, being understood that at the end of the operation of said handling and ordered collecting group 2, on its surface it is, in fact, formed a succession of said “mosaics”, each of which, after being formed, is subsequently moved forward to a successive working state so that the surface it occupied on said group 2 can be used to form a successive “mosaic”.

In correspondence of said handling and ordered collecting group 2 there is arranged a transferring device 11 apt at selectively displacing the containers present on the same group 2 towards and into said multi-flat structure 3, and precisely into one of said hollow spaces 5A, 6A, 7A . . .

Said transferring device can be made in various ways, and by means of pushers, belts, rollers etc.; furthermore such mechanisms, their mode of operation and their purpose are well known in the art, and therefore they are not included in the present invention and consequently they are not described any further.

In order to lift sequentially said multi-flat structure, there are provided lifting means, not specifically described, apt at lifting selectively and in sequence said whole multi-flat structure 3 at successive levels such that, in said respective levels, one at a time the various said rigid planes 5, 6, 7, 8 . . . are basically at the same level as the upper surface of said group 2, so that when a container is on said group 2, it is possible, through the means comprised in said transferring device 11, to displace said container on said plane (of said open multi-flat frame), which at the moment is at the same level of said group 2.

Furthermore, the apparatus is provided with control and command means apt at activating in a sequential and coordinated way the just described organs so that it is possible to insert in each one of said hollow spaces 5A, 6A, 7A . . . respective loads or mosaics formed by one or more containers displaced by said transferring device 11 and subsequently to move in height said multi-flat structure 3 so as to present, at the same height of said group 2, a different still empty hollow space, and hence to repeat the loading operation of said new hollow space by activating again the transferring device 11 so as to displace a new load of containers (previously pushed onto said group 2).

In essence, it is possible to load all the hollow spaces with the respective loads of containers, and hence said multi-flat structure 3 becomes and operates as a very efficient storing means to store temporarily and vertically a plurality of loads of containers which have previously been supplied in sequence by said conveyor 1.

That function carried out by said multi-flat structure 3 not only allows to store, in a limited surface corresponding to the base of the multi-flat structure 3, a load that otherwise would require a much larger space (the same as the sum of the spaces occupied by the single loads/mosaics inserted in the various hollow spaces), but above all it avoids engaging, in a continuative way, all the other downstream organs, as it will be described at length later.

Beside said open multi-flat structure 3 there is arranged a horizontal plate 12 basically having the same dimensions of said rigid planes 5, 6, 7, 8 . . . and basically at the same level, or slighter lower than the level wherein said rigid planes 5, 6, 7, 8 . . . are when each one of them is raised at the level of said handling and ordered collecting group 2.

Said plate 12 is comprised in the assembly normally called “palletizer”, as it will be described later.

At this point it is necessary to completely clarify the following fact: in order to push out the various loads/mosaics from the respective hollow spaces formed in said multi-flat structure 3, different solutions and means are possible; at this operation step, a first solution would be, very simply, to use the same transferring device 11 to push or push out the containers/mosaics from the respective hollow spaces 5A, 6A, 7A . . . and move them on the plate 12; anyway said function can be achieved not only through said transferring device 11, but through any other means apt at carrying out the same function.

In fact, it has been seen that the control and actuating organs of the device 11 become particularly burdensome under the operating point of view, and mechanically bulky if it is desired to use said transferring device 11 for both functions of:
initially inserting the mosaics into the respective hollow spaces,
and then, after having completely “loaded” said structure 3, pushing out the same mosaics and move them on said plate 12.

This inconvenience can be overcome simply providing a suitable pusher means 18, shown in figures from 4 to 7, which, suitably made and controlled, is able of carrying out the function regarding only the expulsion of the mosaics out of the respective hollow spaces and displace them on said plate 12.

Since said pusher 18 is a device known per se and easy to realize by the skilled in the art, such device will not be described any further.

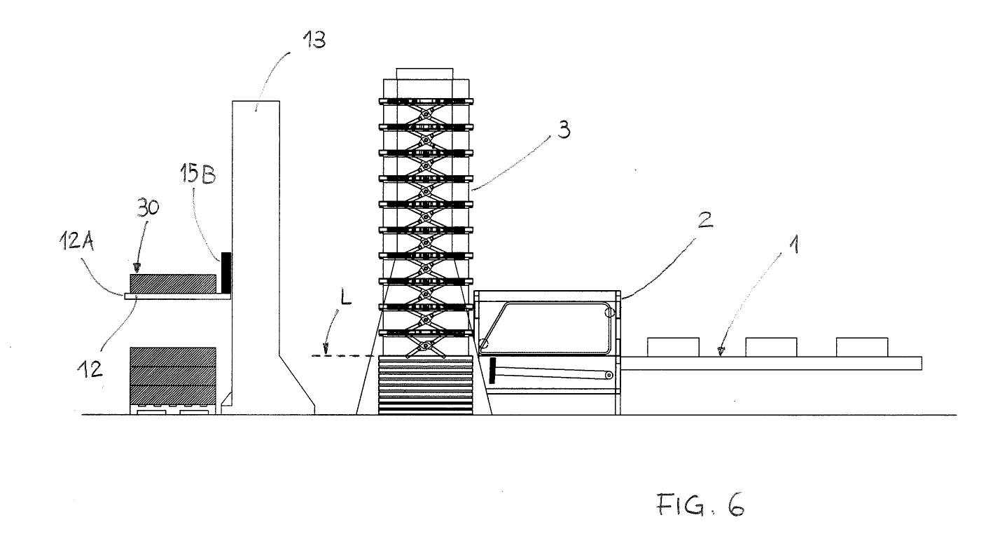

With reference to FIGS. 2 and from 5 to 7, said plate 12 is not fixed, but it is able to further move horizontally and selectively vertically with respect to an articulated frame 13; in particular it is made capable of carrying out the following motions:
to move horizontally until it places itself vertically (arrow “B”, FIG. 5) over an underneath pallet 20,
to lower or lift itself for a predetermined travel (ARROW “A”, FIGS. 6 and 7) so as to lay or almost on the underneath pallet, if the latter is still empty, or on the load of containers, if the pallet is already partially loaded with them.

Said two motions can be in the shown sequence or in the reverse; what is important is that, with any type of motion, said second plate with its load of containers/mosaics 30 is positioned immediately on the pallet or on the load already placed on it, so as to continue the loading of the pallet with other loads of containers to place on the upper container/mosaic of the already formed stack, or which is being formed on said pallet.

For a reason which will soon be explained, in a position suitably raised with respect to said plate 12 in motion and almost at the outer end 12A of the plate 12 there is arranged a retaining means, ideally a wall 15, which is made able of acquiring two positions, a raised one 15A and a lowered one 15B.

In the first raised position 15A, said wall does not impede either the motion of said plate 12, or the consequent displacement of the load of containers which lean on it, and previously pushed thereon by said transferring device 18.

In the second lowered position 15B, said wall 15 is lowered to almost touch said plate 12 from above, but especially it is lowered basically at almost the same level of the load of containers on the same plate 12.

Furthermore, with reference to FIGS. 5, 6 and 7, of course the position of said wall 15 with respect to the plate 12 is that so as to allow that the union of the length of the travel of the plate 12 towards and on the pallet, together with the size and initial position of the load/pallet 30 on said plate 12, is such that, after the travel of the plate 12 on the pallet, as in FIG. 6, said wall 15 is located over and in a rear position with respect to the load 30, so as to allow that, if said wall 15 is lowered onto said plate 12, see FIG. 7, and the latter is pushed out with a backward motion (see FIG. 4), the wall 15 is an obstacle to the motion backward of the load 30 too, which therefore is forced to slide out of the plate 12 and to lay on the underneath pallet, or on the load already placed there.

In particular said wall 15 follows the changing of the level of the plate 12, yet keeping the relative initial position, in the sense that, if said plate 12 lowers, then said wall 15 lowers as well, but keeping its initial height with respect to the plane of the same plate 12.

Anyway, as it will become more apparent later, such constraint lasts only during the motion of the plate 12 when loaded, and it stops after it has placed its load on the pallet or on other containers underneath.

Hence it is also possible to carry out the final loading operation of the load of containers/mosaics placed on said plate 12 moving it first, along said horizontal travel “B”, then along said vertical travel “A” (or vice versa, as already said), then to lower said wall 15 to the position 15A, and finally to displace said plate with a backward motion.

In this way it is necessary that, in the raised position 15A, said wall 15 allows the plate 12 and the relative load of containers to pass, and in the subsequent lowered position 15B it prevents the load leaning on the plate 12 from following said plate in its backward motion towards its initial position, that is beside said open structure 3.

After having reached its unloading position (FIG. 6) the plate 12 is retracted to start a new cycle, but the load of containers placed thereon cannot follow its backward motion as this is prevented by the opposition of the wall 15 lowered in the position 15A, and therefore, the containers, no longer supported by the plate 12 which is pushed out underneath, slide on the upper surface of said plate 12 until they go beyond its outer edge 12A (FIGS. 4, 6, 7), by which they are automatically placed on the underneath plane, that can be either the same pallet or a previous load/mosaic of containers already placed on the pallet.

With reference to FIGS. 5, 6 and 7, the first assembly formed by:
said articulated frame 13,
said plate 12,
said wall 15,
and a pusher 18 if needed,
   form a palletizer able to serve and to operate in coordination with the second assembly formed by:
said mobile conveyor 1
said handling and ordered collecting group 2 first plate,
said transferring device 11,
and said multi-flat structure 3.

Anyway the solution of the multi-flat structure/structures 3 easily generates the problem that the vertical bulk of those structures that could also be very high, and that therefore have to be raised and lowered for a remarkable travel, would require a considerable installation difficulty to assemble said multi-flat structure 3, with considerable overall burdens.

In fact, in case it is desired to access the hollow spaces arranged in the higher positions, it would be necessary to lower the same structure by an equivalent height, which would most likely imply also a hole to house said structure when the latter is completely lowered.

In order to avoid this inconvenience, and with reference to FIGS. 7, 8 and 9, said structure is formed so that it is possible to reduce the height of each hollow space considerably; such characteristic can be achieved making said vertical posts 111, 112, 113, 114 not like rigid poles, but like a plurality of pairs of elements inclinable one another with respect to a respective common pivot, wherein each pair of said elements joins a corner of each plane to the corresponding (vertically) corner of the plane above.

For exemplification only, and with reference to FIG. 3, there are shown the two planes 5 and 6, which are joined by four pairs of arms 40, 40A,—41, 41A,—42, 42A,—and 43, 43A where the common ends of the arms of each pair are interconnected by the respective pivots, 40B, 41B, 42B and 43B.

Of course such construction is repeated in the same way for all the pairs of adjacent planes, so as to achieve the configuration clearly shown in FIGS. 8, 9 and 10.

Therefore all said planes are made and connected so as to be both separate, condition which forms respective said hollow spaces, and basically laying one on the other, condition which forms the lowest vertical dimension of the whole structure.

In this way it has an “accordion-like” type or “folding” configuration, as it can easily be verified observing together FIGS. 8, 9 and 10.

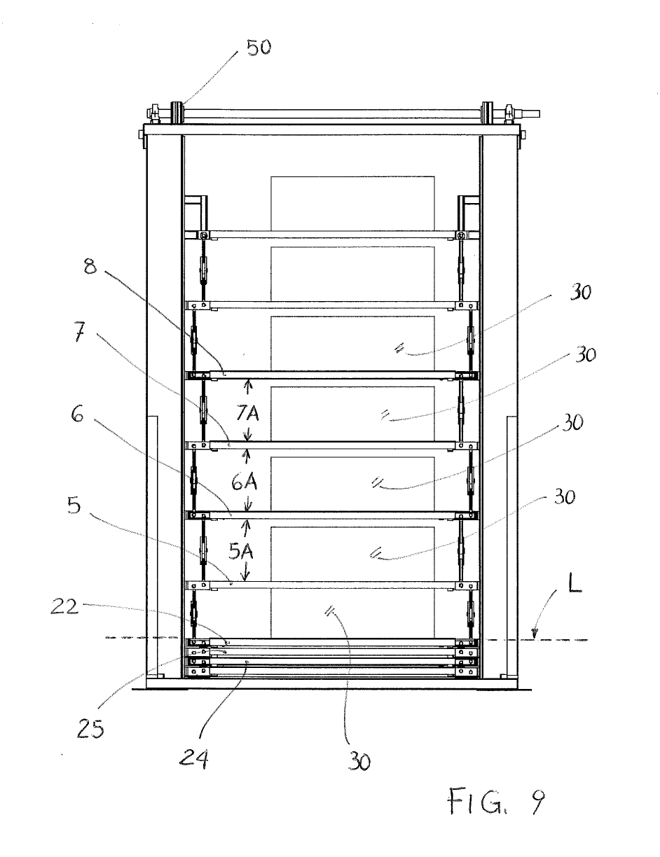

Let's refer to FIGS. 8 and 9: normally said structure is formed and arranged folded, that is its height occupies the minimum space; in this state the single planes 5, 6, 7, 8 . . . almost completely correspond one to the other, and the respective hollow spaces are basically eliminated.

Let's arrange high on said structure lifting/lowering means 50 which, suitably engaged on the upper part of the structure and, suitably controlled, are capable of lifting progressively and in sequence the first upper plane, and after that the successive lower plane, and so on; to lift one by one all the planes so as to open the respective hollow spaces.

FIG. 9 shows an intermediate arrangement of such structure, wherein only the planes 5, 6, 7, 8 . . . arranged on the upper part at a level “L” are separate one from the other so as to realize one with the other the respective hollow spaces, whereas the planes 22, 23, 24 . . . arranged lower than level “L”, are basically flattened one on the other and therefore basically they do not occupy any space vertically.

On the contrary, when said structure is completely opened, it is as in FIG. 10, wherein it reaches its maximum height, but also it has all the respective hollow spaces in an “open” arrangement, and hence it has the maximum capacity to house the greatest number of loads in the respective hollow spaces and therefore it offers the best performance as a temporary storage (BUFFER).

Of course, the dimensions and geometry of the described elements have to be such that, starting from the initial moment, with said structure completely contracted and shortened on the bottom, said hollow spaces open one after the other and all of them at the same level “L”, as shown in FIG. 9, where said level is exactly at the level of said group 2, which also corresponds to about the initial level of said plate 12.

How to realize the devices and means so that the planes 5, 6, 7, . . . 22, 23, 24 . . . , are reciprocally moved away and approached can be easily inferred and used from the prior art, and hence they do not belong to the present invention.

It only has to be taken into consideration that, just due to the fact that said structure 3 is opened starting from the upper hollow space, and one by one all the other lower hollow spaces are successively opened, it will result that, obviously, when all the hollow spaces of said multi-flat structure 3 are loaded with the respective loads, then necessarily the lower hollow space will be at the level of both said group 2 and said plate 12.

At this point, in order not to change the vertical position of said structure, it will be suitable and consistent to start the unloading of the various loads of containers just starting from the last load inserted, and that is from the load which is in the lowest hollow space.

And hence from this moment on, after the load/mosaic 30 has been pushed out, by the known means, such as, but not necessarily, said pusher 18, the respective hollow space that at that moment is at its same level, said structure 3 is lowered by a step, that is the hollow space that was previously above the just unloaded hollow space is brought to the level of the pusher 18, and so on until the complete unloading of all the hollow spaces and until the multi-flat structure 3 has the arrangement shown in FIG. 8, wherein all the hollow spaces are, in fact, pressed and therefore annulled as the respective planes become adjacent one to the other.

Having so defined the apparatus of the invention, it will now be synthetically described its typical operation.

Suitable control and command means, and the just described organs, are made capable of cyclically carrying out the following sequence of operations:
a) activation of said handling and ordered collecting group 2 so that more successive containers are displaced and placed to form a sole mosaic leaning on said group 2; anyway, this technique is completely known and it will not be described any further, SEE FIGS. 1A, 1B, 1C, 1D,
b) activation of said transferring device 11 so as to displace said container 30 into the hollow space which lies at the same level of said group 2;
c) raising of said open multi-flat structure 3 so that the subsequent lower hollow space opens upward and is positioned at the same level of the upper surface of said group 2, see FIG. 4;
d) activation according to the previous steps from a) to c) until all or a pre-defined part of said hollow spaces is loaded;
   After said open multi-flat structure has been loaded in said hollow spaces, as pre-determined,
e) activation of said pusher 18 so that a container or a mosaic, is pushed out from the respective hollow space towards and on said plate 12; as explained above, it is preferred that the first hollow space to be “emptied” is the lower hollow space, see FIG. 1E, FIG. 5;
f) horizontal displacement of said second plate 12 so that it is moved over a respective pallet 100, as symbolically shown in FIG. 1F and FIG. 6;
g) lowering and/or possible raising of said plate 12 to a pre-determined level, see FIGS. 1G and 7;
h) lowering of said wall 15 so as to oppose itself to the backward motion of the container at that time placed on said plate 12, see FIG. 7;
i) backward displacing of said plate 12 and successive raising/lowering so that it returns back to its initial position;
j) raising of said wall 15 to its not interfering initial position;
k) raising of said multi-flat structure 3 until the successive and upper hollow space is brought to the level of said upper plane of said group 2, repetition of the previous steps from e) to k) for a pre-determined number of cycles.

It is to note that normally the various mosaics are loaded in succession on the same pallet until the load final height is at a level lower than the second plate 12, so that the latter has necessarily to lower, a little or a lot, in order to get to the level of the upper mosaic of the stack already arranged on the pallet, on which upper mosaic the plate itself has to unload the mosaic it is displacing at the moment; anyway it is possible that at a given moment said stack is already at a level higher than the level of said second plate 12; of course in that case the operations have to be reversed, and that is said plate 12 first has to raise up to the upper level of the stack, and only after having reached such level it displaces itself horizontally in order to be over the stack.

Therefore in this second case the operations shown at the previous points f) and g) have to be reversed.

As the skilled in the art has already understood, some of the above described steps can also be carried out not necessarily in the identical described order.

In fact, just as it is a question of activating different organs that can operate in “masked time” it will be possible that some steps are anticipated without affecting the successive steps; for example it is possible that, after the load has been pushed out from the respective hollow space and is already on the plate 12, the structure 3 can already place itself so as to present a new hollow space, ready to be emptied, before said group 2 and respective transferring device 11, even if the just displaced load has not been laid on the final pallet yet.

Since there can be different embodiments, but basically equivalent under the point of view of the desired result, these technical equivalents, well conceivable by the skilled in the art, will not be described any further.

In particular it has to be seen that, until the multi-flat structure 3 has not been completely loaded (or loaded up to a pre-determined level), and hence the previous steps from a) to d) have not been carried out completely, the successive steps from e) on do not have to be carried out since clearly it is not possible, in the same time interval, to carry out both the loading of the structure 3, through the steps from a) to d), and its unloading, through the steps from step e) on.

As well, it is also possible that said group 2 forms a new mosaic before the structure 3 places itself at a new level in order to receive this new mosaic.

Of course, other examples can be given but the skilled in the art is certainly capable of determining easily all the possible ways and therefore, a detailed listing is avoided.

Said first assembly or palletizer is known per se and widely used in the art, and therefore it is not part of the invention; anyway it has been described in order to understand in general all the main operating organs of the apparatus of the invention.

Anyway, if such palletizer were stable and fixed, it would occur that it could operate only with said second assembly as previously defined, and which comprises:
said mobile conveyor 1,
said handling and ordered collecting group 2,
said transferring device 11,
and said multi-flat structure 3.

And hence, if it were desired to work and palletize also containers coming from other conveyors, different from the conveyor 1 considered so far, of course it would be necessary to provide other respective palletizers, which would imply a remarkable constructive complication and above all a huge increase of costs.

Examining attentively the workload on the palletizer, this increase of costs shows to be basically unnecessary and mainly inefficient as it can be seen that the palletizer operates only for a very small fraction of the available time, having to wait that the single loads of containers 30 coming from the conveyor 1 arrive at a pace much slower than the operation and loading speed of the palletizer.

And hence the palletizer remains waiting, and therefore stationary, and ultimately economically inefficient, for most part of the available time.

The present invention therefore solves this great inconvenience, since, with reference to FIGS. 11 and 12, an advantageous improvement of the invention, in an apparatus comprising more distinct mobile conveyors 1, 101, 102, 103 . . . and having an independent mode of operation, and associated to respective second assemblies 1-S, 101-S, 102-S, 103-S . . . as previously defined, it consists in eliminating each single palletizer integrated with each mobile conveyor, and in using one sole palletizer which is made mobile, in the sense that it is provided with means, known per se, such as guides, rails etc . . . 16 able of moving it towards other second assemblies, operatively similar to the just described second assembly. These second assemblies too are integrated to a respective said mobile distinct conveyor 1, 101, 102, 103 . . . whereon are loaded containers also of a different type and of course variable both in size and load, a handling and ordered collecting group 2, a transferring device 11, and a respective multi-flat structure, with which it integrates operatively and temporarily.

In this way the present advantageous improvement envisages to store as in a temporary “buffer” all the containers coming from a sole conveyor yet without engaging a respective palletizer rigidly associated to that conveyor; in fact, the described palletizer becomes a sole one as it can be programmed and controlled so as to be moved and in the meantime work with other second assemblies (defined before), which optimizes its construction and its use; basically it is realised the integrated operation mode known as “masked time” well known in other sectors and which, therefore, will not talked about.

Hence this improvement, which consists in associating a single palletizer to a plurality of different assemblies, each comprising a respective conveyor, allows to achieve the very important advantage of using the same palletizer to palletize, on different pallets, all the containers coming from respective and different conveyors.

And this fundamental improvement is, in fact, based on the fact that a sole palletizer can be moved from any second assembly, wherein the loading of the respective multi-flat structure 3 is being carried out, to another second assembly wherein the loading of the respective multi-flat structure has already been completed, where therefore it becomes possible to carry out the loading function of the respective pallet according to the above described method, while in the other second assemblies it is carried out and completed the loading of the respective and successive loads of containers coming from the respective conveyors.

Hence the fundamental object of the invention is achieved, since, in fact, it can be used a sole palletizer to load the containers coming from different conveyors, and at the same time the feeding of the containers from the single conveyors is not affected not even slowed down in any way since the single containers, when in the unloading area, are temporarily loaded in the respective multi-flat structure, waiting to be loaded on the respective pallet, in sequence and without undesired waiting time.

A further fundamental improvement, essential for the best utilization of the invention, consists in the following:

if the functional organs of such apparatus comprising:
distinct mobile conveyors 1, 101, 102, 103 . . . ,
all the respective second assemblies 1-S, 101-S, 102-S, 103-S . . . ,
the respective transferring devices 11 (for brevity the corresponding ones of the other assemblies are not identified),
possible and respective said unloading third pushers 18,
   and furthermore the described organs of said sole palletizer, and the means apt at moving it on said guides, rails, etc 16, so as to functionally and selectively associate it to said second assemblies 1-S, 101-S, 102-S, 103-S . . . are suitably associated and connected to a single command and control system, and if such system is suitably programmed, it becomes possible and immediate to control and command all the functions of such apparatus in a coordinated, automatic and coherent way according to the different variables that may occur and that have to be appropriately taken into consideration and planned, and that is of the loading of pallets with containers which therefore can be different:
in size,
in the frequency of arrivals on their respective conveyor,
in the type of pallet
in the load height on each single pallet, or in the number of layers of containers that have to be loaded on each single pallet of a pre-determined type, of course, everything can change over time.

1. An apparatus for the loading on pallets a plurality of containers/mosaics, particularly containing vegetable products, and comprising:
a first assembly or palletizer,
a conveyor having an horizontal motion,
an handling and collecting group arranged downstream said conveyor and provided with a leaning plane able of supporting one or more containers,
wherein it comprises temporary vertically storing means and substantially adjacent to said handling and collecting group and able of accumulating into a vertical standing, for a pre-determined quantity, said containers/mosaics, and successively of transferring them in sequence and singularly towards and into said first assembly or palletizer.

2. The apparatus according to claim 1, wherein said temporary vertically storing means comprises:
an open multi-flat structure consisting of a plurality of basically similar leaning planes and placed vertically one by one, and separated by respective hollow spaces,
lifting/lowering means able of vertically displacing the position of said open multi-flat structure to a plurality of selectively defined levels and in a selectively controllable sequence, wherein at each level a defined of said hollow spaces is so arranged in height substantially to the same level of said leaning plane of said handling and collecting group.

3. The apparatus according to claim 2, wherein said palletizer comprises:
a plate arranged beside said open multi-flat structure,
an articulated frame able of selectively conveying with horizontal and vertical motion said plate,
retaining means, preferably a vertical wall, combined with said plate and able of being placed selectively into two positions, wherein in a first raised position it is able of leave said containers, laying on said plate, to pass on, and in a second position it is lowered basically at the same level of said plate,
a possible third means for horizontal motion, particularly a pusher, able of transferring said containers/mosaics out from the respective hollow spaces they are lodged in, towards and on said plate.

4. The apparatus according to claim 1, wherein said open multi-flat structure comprises a plurality of vertical posts which are able of selectively being:
shortened so that said leaning planes, arranged in an ordered succession, are substantially and reciprocally approached moving from an initial separation position, so that the height of the respective said hollow spaces is remarkably reduced,
and re-stretched so that said leaning planes are again spaced from each other until getting back said initial position.

5. The apparatus according to claim 4, wherein said lifting/lowering means are able of implementing the raising of said leaning planes in sequence and starting from the upper plane, so that the hollow spaces are opened in sequence starting from the upper hollow space, and of implementing their lowering starting from the lower leaning plane, so that said hollow spaces are closed in sequence starting from the lower hollow space.

6. The apparatus according to any of the previous claims, wherein it is able of operating according to the following modes, also in a not consecutive mode:
i. activation of said handling and collecting group so to arrange on it one or more successive containers,
ii. activation of a transferring device to displace said one or more containers into the hollow space which lies at the same level of the upper plane of said handling and collecting group,
iii. raising of said open multi-flat structure so that the lower hollow space is positioned at the same level of the upper plane of said handling and collecting group,
iv. further operation according to the previous steps from i. to iii. until all or a pre-defined part of said hollow spaces are loaded,
v. activation of shifting means, preferably a pusher so that one or more containers are pushed out from the respective hollow space towards and on said plate,
vi. horizontal displacement of said plate so that it is moved over a respective pallet,
vii. lowering/raising of said plate to pre-determined level,
viii. lowering of said retaining means or wall,
ix. backward displacing of said plate and successive return back to its initial position,
x. raising of said retaining means or wall to its initial position,
xi. lowering of said open multi-flat structure until the successive and upper hollow space is brought to the level of said the upper plane of said handling and collecting group,
xii. further operation according to the previous steps from v. to xi. for a predetermined number of cycles.

7. The apparatus according to claim 6, wherein it comprises:
a plurality of distinct assemblies each of them being associated to a respective conveyor, and provided with a respective handling and collecting group, with a respective transferring device and with a respective said open multi-flat structure,
and also comprises:
one sole palletizer provided with a respective plate, a vertically moving means or wall, and a respective articulated frame,
transferring means of said sole palletizer towards and near selectively one of said distinct assemblies.

8. The apparatus according to claim 7, wherein it comprises command and control means able of moving said sole palletizer towards and near to said distinct assemblies when said hollow spaces of respective said open multi-flat structure are loaded to a pre-defined amount or level.

9. The apparatus according to claim 8, wherein said command and control means are able of make said apparatus to operate in pre-defined conditions, and especially to operate the previous steps from “v.” to “xii.” only after a plurality of said hollow spaces is loaded with respective said containers/mosaics.

10. The apparatus according to claim 2, wherein said open multi-flat structure comprises a plurality of vertical posts which are able of selectively being:
shortened so that said leaning planes, arranged in an ordered succession, are substantially and reciprocally approached moving from an initial separation position, so that the height of the respective said hollow spaces is remarkably reduced,
and re-stretched so that said leaning planes are again spaced from each other until getting back said initial position.

11. The apparatus according to claim 3, wherein said open multi-flat structure comprises a plurality of vertical posts which are able of selectively being:
shortened so that said leaning planes, arranged in an ordered succession, are substantially and reciprocally approached moving from an initial separation position, so that the height of the respective said hollow spaces is remarkably reduced,
and re-stretched so that said leaning planes are again spaced from each other until getting back said initial position.

12. The apparatus according to claim 2, wherein it is able of operating according to the following modes, also in a not consecutive mode:
i. activation of said handling and collecting group so to arrange on it one or more successive containers,
ii. activation of a transferring device to displace said one or more containers into the hollow space which lies at the same level of the upper plane of said handling and collecting group,
iii. raising of said open multi-flat structure so that the lower hollow space is positioned at the same level of the upper plane of said handling and collecting group,
iv. further operation according to the previous steps from i. to iii. until all or a pre-defined part of said hollow spaces are loaded,
v. activation of shifting means, preferably a pusher so that one or more containers are pushed out from the respective hollow space towards and on said plate,
vi. horizontal displacement of said plate so that it is moved over a respective pallet,
vii. lowering/raising of said plate to pre-determined level,
viii. lowering of said retaining means or wall,
ix. backward displacing of said plate and successive return back to its initial position,
x. raising of said retaining means or wall to its initial position,
xi. raising of said open multi-flat structure until the successive and upper hollow space is brought to the level of said the upper plane of said handling and collecting group,
xii. further operation according to the previous steps from v. to xi. for a predetermined number of cycles.

13. The apparatus according to claim 3, wherein it is able of operating according to the following modes, also in a not consecutive mode:
i. activation of said handling and collecting group so to arrange on it one or more successive containers,
ii. activation of a transferring device to displace said one or more containers into the hollow space which lies at the same level of the upper plane of said handling and collecting group,
iii. raising of said open multi-flat structure so that the lower hollow space is positioned at the same level of the upper plane of said handling and collecting group,
iv. further operation according to the previous steps from i. to iii. until all or a pre-defined part of said hollow spaces are loaded,
v. activation of shifting means, preferably a pusher so that one or more containers are pushed out from the respective hollow space towards and on said plate,
vi. horizontal displacement of said plate so that it is moved over a respective pallet,
vii. lowering/raising of said plate to pre-determined level,
viii. lowering of said retaining means or wall,
ix. backward displacing of said plate and successive return back to its initial position,
x. raising of said retaining means or wall to its initial position,
xi. raising of said open multi-flat structure until the successive and upper hollow space is brought to the level of said the upper plane of said handling and collecting group,
xii. further operation according to the previous steps from v. to xi. for a predetermined number of cycles.

14. The apparatus according to claim 4, wherein it is able of operating according to the following modes, also in a not consecutive mode:
i. activation of said handling and collecting group so to arrange on it one or more successive containers,
ii. activation of a transferring device to displace said one or more containers into the hollow space which lies at the same level of the upper plane of said handling and collecting group,
iii. raising of said open multi-flat structure so that the lower hollow space is positioned at the same level of the upper plane of said handling and collecting group,
iv. further operation according to the previous steps from i. to iii. until all or a pre-defined part of said hollow spaces are loaded,
v. activation of shifting means, preferably a pusher so that one or more containers are pushed out from the respective hollow space towards and on said plate,
vi. horizontal displacement of said plate so that it is moved over a respective pallet,
vii. lowering/raising of said plate to pre-determined level,
viii. lowering of said retaining means or wall,
ix. backward displacing of said plate and successive return back to its initial position,
x. raising of said retaining means or wall to its initial position,
xi. raising of said open multi-flat structure until the successive and upper hollow space is brought to the level of said the upper plane of said handling and collecting group,
xii. further operation according to the previous steps from v. to xi. for a predetermined number of cycles.

15. The apparatus according to claim 5, wherein it is able of operating according to the following modes, also in a not consecutive mode:
i. activation of said handling and collecting group so to arrange on it one or more successive containers,
ii. activation of a transferring device to displace said one or more containers into the hollow space which lies at the same level of the upper plane of said handling and collecting group,
iii. raising of said open multi-flat structure so that the lower hollow space is positioned at the same level of the upper plane of said handling and collecting group,
iv. further operation according to the previous steps from i. to iii. until all or a pre-defined part of said hollow spaces are loaded,
v. activation of shifting means, preferably a pusher so that one or more containers are pushed out from the respective hollow space towards and on said plate,
vi. horizontal displacement of said plate so that it is moved over a respective pallet,
vii. lowering/raising of said plate to pre-determined level,
viii. lowering of said retaining means or wall,
ix. backward displacing of said plate and successive return back to its initial position,
x. raising of said retaining means or wall to its initial position,
xi. raising of said open multi-flat structure until the successive and upper hollow space is brought to the level of said the upper plane of said handling and collecting group,
xii. further operation according to the previous steps from v. to xi. for a predetermined number of cycles.
